(19) United States
(12) Patent Application Publication
(10) Pub. No.: US 2026/0302499 A1
(43) Pub. Date: Oct. 1, 2026

(54) BATTERY MODULE

(71) Applicant: HONDA MOTOR CO., LTD., Tokyo (JP)

(72) Inventors: Hidemasa USUI, Saitama (JP); Hirokazu WATANABE, Saitama (JP); Kazutaka SUZUKI, Saitama (JP); Anri ISHIDE, Saitama (JP); Mahiro SAWADA, Saitama (JP); Tatsuya SEKI, Saitama (JP); Yosuke YOSHIZAWA, Saitama (JP); Kenji TSUKAHARA, Saitama (JP)

(21) Appl. No.: 19/632,433

(22) Filed: Mar. 30, 2026

(30) Foreign Application Priority Data
Mar. 31, 2025 (JP) 2025-060072

(51) Int. Cl. H01M 50/291; H01M 10/0562; H01M 50/242

(52) U.S. Cl. CPC H01M 50/291; H01M 10/0562; H01M 50/242

(57) ABSTRACT

A battery module is provided, the battery module including a battery-cell laminate in which a plurality of battery cells are stacked, and an elastic member disposed between the plurality of battery cells, in which the elastic member includes two pouches that are stacked, in which the pouches include a sealing portion extending in a direction perpendicular to a stacking direction of the battery cells, a gas being sealed in the pouches, and in which the sealing portion faces an adjacent one of the pouches.

This application is based on and claims the benefit of priority from Japanese Patent Application No. 2025-060072, filed on 31 Mar. 2025, the content of which is incorporated herein by reference.

### BACKGROUND OF THE INVENTION

### Field of the Invention

The present invention relates to a battery module.

### Related Art

In recent years, research and development has been conducted on battery modules that contribute to energy efficiency, in order to ensure that a greater number of people can have access to affordable, reliable, sustainable, and advanced energy.

Japanese Unexamined Patent Application, Publication No. 2003-303579 discloses a module including a flat secondary battery. In this case, the module includes a module casing that fixes the flat secondary battery while applying pressure to the flat secondary battery, and a fluid-containing bag that contains a fluid in a sealed state, the fluid-containing bag being disposed between the module casing and the flat secondary battery.

Patent Document 1: Japanese Unexamined Patent Application, Publication No. 2003-303579

### SUMMARY OF THE INVENTION

However, when the fluid-containing bag disclosed in Japanese Unexamined Patent Application, Publication No. 2003-303579 is disposed between a plurality of battery cells, air enters between the fluid-containing bag and the battery cells, and uniformity of surface pressure tends to decrease.

An object of the present invention is to provide a battery module in which uniformity of surface pressure of an elastic member can be increased.
(1) A battery module including a battery-cell laminate in which a plurality of battery cells are stacked, and an elastic member disposed between the plurality of battery cells, in which the elastic member includes two pouches that are stacked, the pouches include a sealing portion extending in a direction perpendicular to a stacking direction of the battery cells, a gas is sealed in the pouches, and the sealing portion faces an adjacent one of the pouches.
(2) The battery module as described in the item (1), in which the elastic member includes the two pouches stacked such that the sealing portions do not interfere with each other.
(3) The battery module as described in the item (1) or (2), further including a plate-like member disposed between the two pouches.
(4) The battery module as described in the item (3), in which the plate-like member has a thermal conductivity of 1 W/(m·K) or more.
(5) The battery module as described in the item (1) or (2), further including a corrugated leaf spring disposed between the two pouches.
(6) The battery module according to any one of items (1) to (5), in which an internal pressure of the pouches is between 0.1 MPa and 3.0 MPa inclusive.
(7) The battery module according to any one of items (1) to (6), in which the elastic member further includes elastic foams disposed respectively on both sides, in the stacking direction of the battery cells, of the two stacked pouches.
(8) The battery module according to any one of items (1) to (7), in which the battery cells include a cell including a negative-electrode composite layer including lithium metal or a lithium alloy.
(9) The battery module according to any one of items (1) to (8), in which the battery cells include a solid battery cell.

According to the present invention, a battery module can be provided, in which uniformity of surface pressure of an elastic member can be increased.

### BRIEF DESCRIPTION OF THE DRAWINGS

FIG. 1 is a side view illustrating a battery module according to an embodiment of the present invention;

FIG. 2A is a partially enlarged perspective view of the battery module of FIG. 1;

FIG. 2B is a schematic view illustrating a cross-section taken along the line A-A in FIG. 2A;

FIG. 2C is a schematic view illustrating a cross-section taken along the line B-B in FIG. 2A;

FIG. 3A is a schematic view illustrating a cross-section of a modified example of the battery module of FIG. 2B;

FIG. 3B is a schematic view illustrating a cross-section of a modified example of the battery module of FIG. 2C; and

FIG. 4 is a schematic view illustrating a cross-section of a modified example of the battery module of FIG. 2B.

### DETAILED DESCRIPTION OF THE INVENTION

Embodiments of the present invention will be described below with reference to the drawings.

### Battery Module

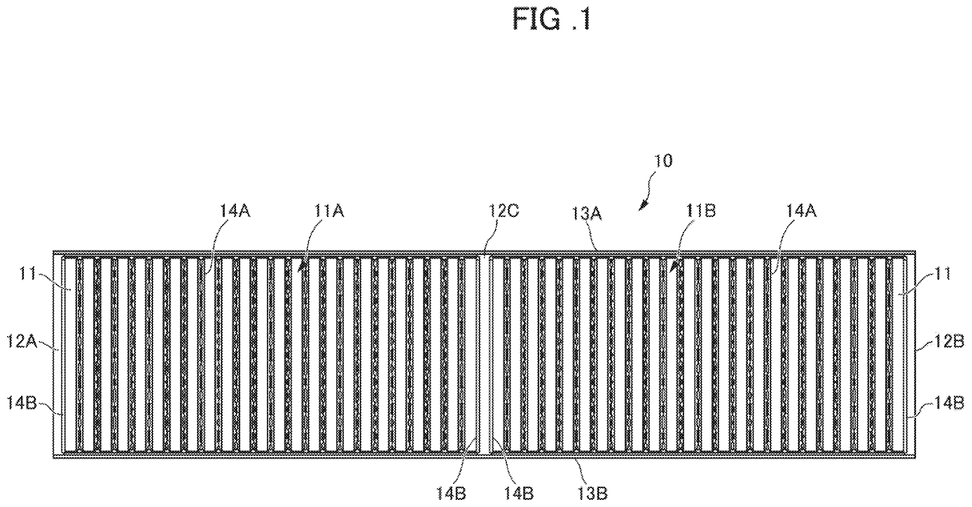

FIG. 1 illustrates a battery module according to an embodiment of the present invention.

A battery module 10 includes: battery-cell laminates 11A and 11B in which a plurality of battery cells 11 are stacked; end plates 12A and 12B provided respectively at both ends in a stacking direction of the battery-cell laminates 11A and 11B; and a center plate 12C provided between the battery-cell laminates 11A and 11B. The battery module 10 includes bind bars 13A and 13B configured to restrain the battery-cell laminates 11A and 11B between the end plates 12A and 12B. A restraining pressure applied by the bind bars 13A and 13B is not particularly limited and is, for example, between 1.0 MPa and 2.5 MPa inclusive.

In the battery module 10, a first elastic member 14A is disposed between the plurality of battery cells 11, and a second elastic member 14B is disposed between the battery-cell laminate 11A and both the end plate 12A and the center plate 12C, and between the battery cell 11 and both the end plate 12B and the center plate 12C. In this case, the elastic member 14B is in contact with one battery cell 11; therefore, the elastic member 14B is not particularly limited as long as the elastic member 14B has elasticity equal to or greater than approximately half of elasticity of the elastic member 14A that is in contact with two battery cells 11. From the viewpoint of energy density of the battery module 10, it is preferable that the elastic member 14B have a thickness approximately half of that of the elastic member 14A and have the same configuration as the elastic member 14A, but the elastic member 14B may be identical to the elastic member 14A.

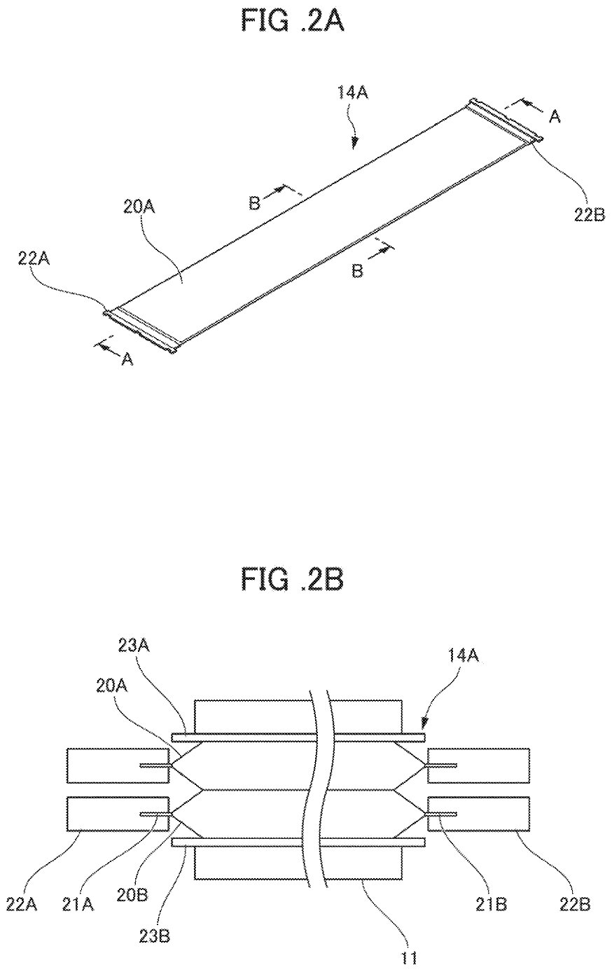

As illustrated in FIGS. 2A, 2B, and 2C, the elastic member 14A includes pouches 20A and 20B that are stacked. A pouch 20A (or 20B) includes a third sealing portion 21C extending in a longitudinal direction (A-A direction) perpendicular to the stacking direction of the battery cells 11, and a gas is sealed in the pouch 20A (or 20B). In this case, the third sealing portion 21C faces an adjacent pouch 20B (or 20A). Therefore, even if air enters between the pouch 20A (or 20B) and an elastic foam 23A (or 23B) described later, uniformity of surface pressure of the elastic member 14A increases. This also applies to the case where the elastic foams 23A and 23B are omitted. In FIG. 2A, illustration of the battery cells 11 and the elastic foams 23A and 23B is omitted.

The elastic member 14A includes the pouches 20A and 20B stacked such that the third sealing portions 21C do not interfere with each other. Therefore, uniformity of surface pressure of the elastic member 14A increases.

An internal pressure of the pouches 20A and 20B is preferably between 0.1 MPa and 3.0 MPa inclusive, and more preferably between 1.0 MPa and 2.5 MPa inclusive. When the internal pressure of the pouches 20A and 20B is 0.1 MPa or more, uniformity of surface pressure of the elastic member 14A increases, and when the internal pressure is 3.0 MPa or less, damage to the pouches 20A and 20B is reduced even when the battery cells 11 expand and contract during charging and discharging of the battery cells 11.

As illustrated in FIG. 2B, the pouch 20A (or 20B) includes a first sealing portion 21A and a second sealing portion 21B at both ends, respectively, in the longitudinal direction (A-A direction) perpendicular to the stacking direction of the battery cells 11.

In this case, the elastic member 14A further includes: a first support member 22A that supports substantially the entire region of the first sealing portion 21A; and a second support member 22B that supports substantially the entire region of the second sealing portion 21B. The first support member 22A and the second support member 22B are positioned, for example, by positioning members provided in the battery module 10.

As illustrated in FIG. 2B, the elastic member 14A further includes elastic foams 23A and 23B disposed respectively on both sides, in the stacking direction of the battery cells 11, of the pouches 20A and 20B that are stacked. In this case, when the elastic member 14A is compressed due to expansion of the battery cells 11 during charging of the battery cells 11, the elastic foams 23A and 23B are interposed between the battery cells 11 and the pouches 20A and 20B, and uniformity of surface pressure of the elastic member 14A increases.

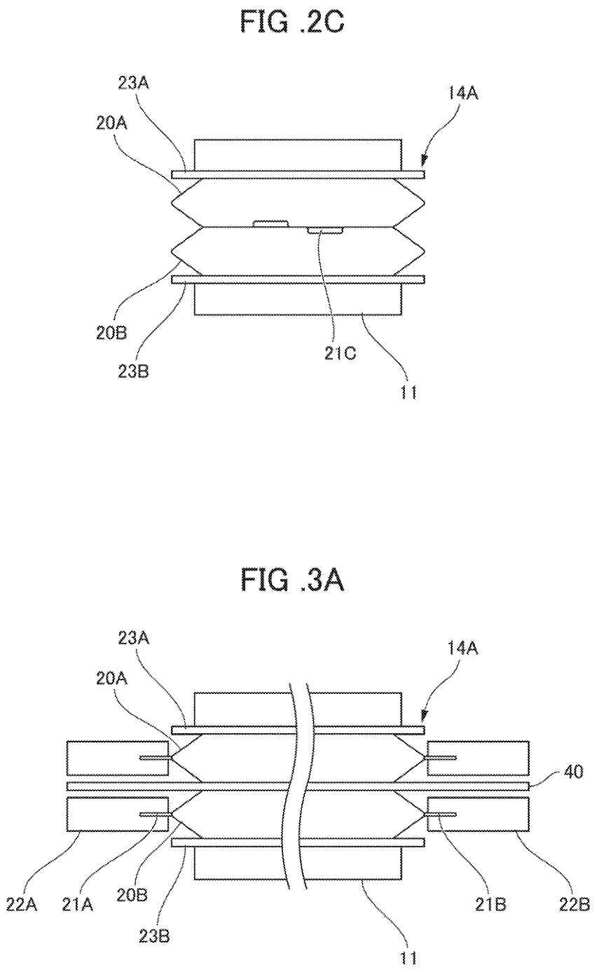

As illustrated in FIGS. 3A and 3B, the elastic member 14A may further include a plate-like member 40 disposed between the pouches 20A and 20B. This suppresses positional misalignment in the stacking direction of the battery cells 11 of the pouches 20A and 20B. A material constituting the plate-like member 40 is not particularly limited and may be, for example, a resin or a metal.

A thermal conductivity of the plate-like member 40 is preferably 1 W/(m·K) or more, and more preferably 3 W/(m·K) or more. When the thermal conductivity of the plate-like member 40 is 1 W/(m·K) or more, temperature increase of the battery cells 11 is reduced. A thermal conductivity of the plate-like member 40 is, for example, 236 W/(m·K) or less. A material having a thermal conductivity of 1 W/(m·K) or more is not particularly limited and may be, for example, a high thermal-conductivity polycarbonate resin, a carbon-fiber-reinforced plastic (CFRP), stainless steel (SUS), or a metal such as an aluminum alloy.

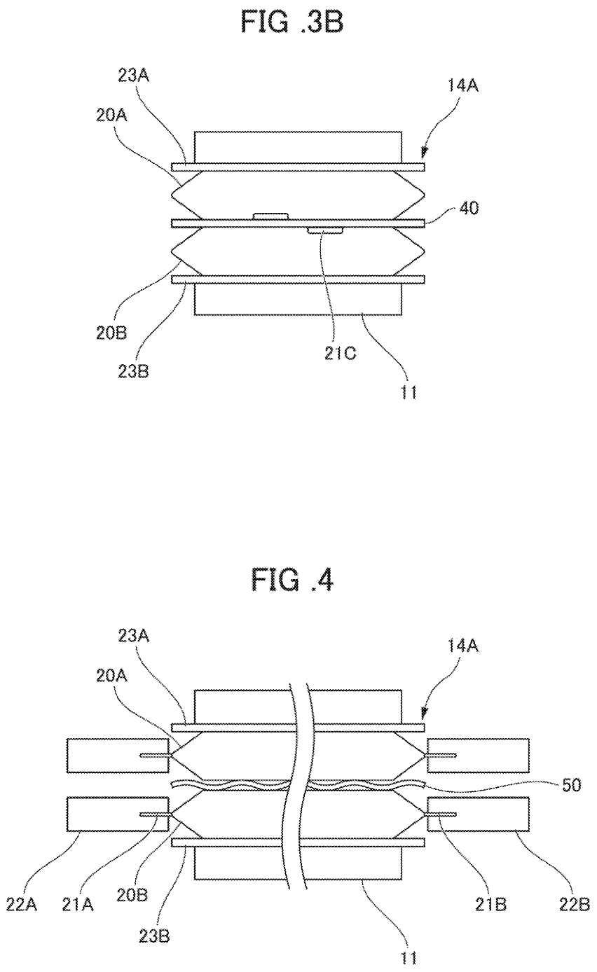

As illustrated in FIG. 4, the elastic member 14A may further include a corrugated leaf spring 50 disposed between the pouches 20A and 20B. This reduces reduction of elasticity of the elastic member 14A even when the pouch 20A or 20B is damaged. The corrugated leaf spring 50 preferably includes a fiber-reinforced plastic (FRP). This allows both heat resistance and thermal insulation of the corrugated leaf spring 50 to be achieved. Examples of FRP include a carbon-fiber-reinforced plastic (CFRP) and a glass-fiber-reinforced plastic (GFRP).

A method of fixing the corrugated leaf spring 50 to the pouch 20A (or 20B) is not particularly limited and may be, for example, a method in which the corrugated leaf spring 50 is bonded to the pouch 20A (or 20B) with an elastic adhesive. The corrugated leaf spring 50 is manufactured, for example, by a press-forming method.

The pouch 20A (or 20B) has stretchability that allows the pouch 20A (or 20B) to follow expansion and contraction accompanying charging and discharging of the battery cells 11 and, as long as sealing is possible, a configuration of the pouch is not particularly limited and may be, for example, a configuration in which an aluminum film is sandwiched between stretchable resin films. Examples of the stretchable resin include, without limitation, polypropylene, polyamide, and polyester.

A method of forming the first sealing portion 21A, the second sealing portion 21B, and the third sealing portion 21C is not particularly limited and may be, for example, a method in which the stretchable resin constituting the pouch 20A (or 20B) is thermally fused.

The pouch 20A (or 20B) is not particularly limited and may be, for example, a pillow pouch (commercial product). A gas sealed in the pouch 20A (or 20B) is not particularly limited and may be, for example, air.

A material constituting the first support member 22A and the second support member 22B is not particularly limited and may be, for example, a resin or a metal.

A Poisson's ratio of the elastic foams 23A and 23B is preferably 0.3 or less. When a Poisson's ratio of the elastic foams 23A and 23B is 0.3 or less, changes in thickness accompanying expansion and contraction of the battery cells 11 are easily absorbed by the elastic foams 23A and 23B. A Poisson's ratio of the elastic foams 23A and 23B is, for example, 0.01 or more.

A thickness of the elastic foams 23A and 23B when a state of charge of the battery cells is 100% is not particularly limited and is, for example, between 0.05 mm and 0.1 mm inclusive.

A porosity of the elastic foams 23A and 23B is not particularly limited and is, for example, between 30% and 95% inclusive. A material constituting the elastic foams 23A and 23B is not particularly limited and may be, for example, polyurethane, silicone resin, ethylene-propylene rubber, styrene resin, olefin resin, polyamide, or polyester.

A method of fixing the elastic foam 23A (or 23B) to the pouch 20A (or 20B) is not particularly limited and may be, for example, a method in which the elastic foam 23A (or 23B) is bonded to the pouch 20A (or 20B) with an elastic adhesive.

### Cell

A cell constituting the battery cell 11 is not particularly limited and may be, for example, a solid battery cell such as an all-solid battery cell or a semi-solid battery cell, or a non-aqueous electrolyte battery cell including a negative-electrode composite layer including lithium metal or a lithium alloy. As elements other than lithium constituting the lithium alloy, examples include, without limitation, Sn, Ag, Mg, In, Si, and Al. Among these, from the viewpoint of energy density, a solid battery cell including a negative-electrode composite layer including lithium metal or a lithium alloy is preferable.

An example of an all-solid battery cell will be described below.

The all-solid battery cell includes a negative-electrode current collector, a negative-electrode composite layer including lithium metal or a lithium alloy, a solid electrolyte layer, a positive-electrode composite layer, and a positive-electrode current collector.

A material constituting the negative-electrode current collector is not particularly limited and may be, for example, silver, palladium, gold, platinum, aluminum, copper, nickel, stainless steel, or carbon. Among these, copper, stainless steel, and nickel are preferable from the viewpoints of conductivity and cost.

A shape of the negative-electrode current collector is not particularly limited and may be, for example, a foil shape, a plate shape, a mesh shape, a nonwoven shape, or a foam shape.

A solid electrolyte constituting the solid electrolyte layer is not particularly limited and may be, for example, a sulfide solid electrolyte or an oxide solid electrolyte.

A form of the solid electrolyte is not particularly limited and may be, for example, particles.

A content of the solid electrolyte in the solid electrolyte layer is not particularly limited and is, for example, between 50 mass % and 99 mass % inclusive.

The solid electrolyte layer may further include a binder or the like.

A method of forming the solid electrolyte layer is not particularly limited and may be, for example, a method in which a slurry containing the solid electrolyte and a solvent is applied.

The positive-electrode composite layer includes a positive-electrode active material. The positive-electrode active material is not particularly limited and may be, for example, lithium cobalt oxide (LiCoO₂), lithium nickel oxide (LiNiO₂), LiNiₚMn_{q}CoᵣO₂ (p+q+r=1), LiNiₚAl_{q}CoᵣO₂ (p+q+r =1), lithium manganese oxide (LiMn₂O₄), Li₁₊ₓMn_{2-x-y}M_{y}O₄ (x+y=2, where M is one or more elements selected from the group consisting of Al, Mg, Co, Fe, Ni, and Zn), lithium titanate, or LiMPO₄ (where M is one or more elements selected from the group consisting of Fe, Mn, Co, and Ni).

A content of the positive-electrode active material in the positive-electrode composite layer is not particularly limited and is, for example, between 50 mass % and 99 mass % inclusive.

The positive-electrode composite layer may further include a solid electrolyte. As the solid electrolyte, as long as conduction of lithium ions is possible, a material is not particularly limited and may be, for example, an oxide solid electrolyte or a sulfide solid electrolyte.

The positive-electrode composite layer may further include a binder, a conductive additive, or the like.

A method of forming the positive-electrode composite layer is not particularly limited and may be, for example, a method in which a slurry containing the positive-electrode active material and a solvent is applied.

A material constituting the positive-electrode current collector is not particularly limited and may be, for example, aluminum, an aluminum alloy, stainless steel, nickel, iron, or titanium. Among these, aluminum, an aluminum alloy, and stainless steel are preferable.

A shape of the positive-electrode current collector is not particularly limited and may be, for example, a foil shape or a plate shape.

Although embodiments of the present invention have been described above, the present invention is not limited to the embodiments described above, and the embodiments described above may be modified as appropriate within the scope of the gist of the present invention.

### EXPLANATION OF REFERENCE NUMERALS

10: battery module
11: battery cell
11A, 11B: battery-cell laminate
12A, 12B: end plate
12C: center plate
13A, 13B: bind bar
14A, 14B: elastic member
20A, 20B: pouch
21A: first sealing portion
21B: second sealing portion
21C: third sealing portion
22A: first support member
22B: second support member
23A, 23B: elastic foam
40: plate-like member
50: corrugated leaf spring

What is claimed is:

1. A battery module, comprising:
a battery-cell laminate in which a plurality of battery cells are stacked; and
an elastic member disposed between the plurality of battery cells,
wherein the elastic member includes two pouches that are stacked,
the pouches include a sealing portion extending in a direction perpendicular to a stacking direction of the battery cells, a gas being sealed in the pouches, and
the sealing portion faces an adjacent one of the pouches.

2. The battery module according to claim 1, wherein the elastic member includes the two pouches stacked such that the sealing portions do not interfere with each other.

3. The battery module according to claim 1, further comprising a plate-like member disposed between the two pouches.

4. The battery module according to claim 3, wherein the plate-like member has a thermal conductivity of 1 W/(m·K) or more.

5. The battery module according to claim 1, further comprising a corrugated leaf spring disposed between the two pouches.

6. The battery module according to claim 1, wherein an internal pressure of the pouches is between 0.1 MPa and 3.0 MPa inclusive.

7. The battery module according to claim 1, wherein the elastic member further includes elastic foams disposed respectively on both sides, in the stacking direction of the battery cells, of the two stacked pouches.

8. The battery module according to claim 1, wherein the battery cells include a cell including a negative-electrode composite layer including lithium metal or a lithium alloy.

9. The battery module according to claim 1, wherein the battery cells include a solid battery cell.
